(19) United States
(12) Patent Application Publication
(10) Pub. No.: US 2026/0119747 A1
(43) Pub. Date: Apr. 30, 2026

(54) METHOD FOR PREDICTING IN-SITU LEACHING MINING EFFECT OF SANDSTONE-TYPE URANIUM DEPOSITS AFTER BLASTING

(71) Applicants: Shijiazhuang Tiedao University, Shijiazhuang City (CN); China University of Mining and Technology, Xuzhou City (CN)

(72) Inventors: Qinghe NIU, Shijiazhuang City (CN); Jie WANG, Shijiazhuang City (CN); Wei WANG, Shijiazhuang City (CN); Shuxun SANG, Shijiazhuang City (CN); Shiqi LIU, Shijiazhuang City (CN); Jiangfang CHANG, Shijiazhuang City (CN); Wei YUAN, Shijiazhuang City (CN); Zhenzhi WANG, Shijiazhuang City (CN)

(73) Assignees: Shijiazhuang Tiedao University, Shijiazhuang City, HE (CN); China University of Mining and Technology, Xuzhou City, JS (CN)

(21) Appl. No.: 19/432,670

(22) Filed: Dec. 24, 2025

(30) Foreign Application Priority Data
Jun. 4, 2025 (CN) 202510739139.6

(51) Int. Cl. G06F 30/23; G06F 30/27; G06F 111/10

(52) U.S. Cl. CPC G06F 30/23; G06F 30/27; G06F 2111/10

(57) ABSTRACT

A method for predicting in-situ leaching effects of sandstone-type uranium mining deposits after blasting is provided, which comprises: based on a finite element analysis platform, establishing an HJC rock-blasting constitutive model, and carrying out a blasting numerical simulation; calibrating a cloud map of blasting crack damage by using a Kriging interpolation algorithm; establishing a COMSOL multiphysics model; establishing a coupling interface between the COMSOL multiphysics model and PHREEQC based on MATLAB, and optimizing a cycle duration and a time step; performing a geochemical reaction calculation and saving results, running COMSOL files, and inputting the results of geochemical reaction calculation into PHREEQC to obtain a dynamic cyclic iterative simulation; dynamically correcting migration coefficients of uranyl complexes by integrating an LSTM neural network, and stopping the cycle to output multi-scale dynamic simulation results of migration of uranium.

### CROSS-REFERENCE TO RELATED APPLICATION

This application claims priority to Chinese Patent Application No. 202510739139.6, filed on Jun. 4, 2025, which is hereby incorporated by reference in its entirety.

### TECHNICAL FIELD

The present disclosure relates to the field of numerical simulation of in-situ leaching mining effect of sandstone-type uranium deposits, particularly to a method for predicting in-situ leaching mining effect of sandstone-type uranium deposits after blasting.

### BACKGROUND ART

Sandstone-type uranium deposits, as an important form of uranium resource occurrence worldwide, the green and efficient development of which are a key link in the nuclear fuel cycle system. The CO₂+O₂ in-situ leaching mining technology has significant advantages such as high resource utilization and minimal environmental disturbance by injecting leaching solution to dissolve uranium ore bodies and recover uranium containing solutions. However, traditional acid leaching methods have problems such as strong corrosiveness of leaching agents and high environmental risks, which restrict their sustainable development. The neutral in-situ leaching technology based on CO₂+O₂ has become a research hotspot in the field of uranium mining due to its characteristics such as wide leaching range and environmental friendliness. However, the multi-field coupling solute transfer mechanism in CO₂+O₂ in-situ leaching mining of sandstone-type uranium deposits after blasting is complex, and systematic research is urgently needed.

Blasting, as a pre-treatment process in uranium mining, releases explosive energy to create a network of fractures in the ore body, altering the permeability and mechanical properties of the rock mass. However, the rock fragmentation, stress redistribution, and temperature field changes caused by blasting loads are coupled with the seepage field and chemical field after leaching agent injection, making it difficult for traditional single-physical-field simulation methods to accurately reveal the migration law of uranium. In addition, the CO₂+O₂ system involves complex multi-phase chemical reactions during the leaching process (such as carbonate dissolution, oxidation and dissolution of uranium oxides, etc.), and its dynamic chemical equilibrium and spatiotemporal evolution characteristics of solute transport have a decisive impact on leaching efficiency and optimization of the leaching agent.

Currently, scholars both domestically and internationally have conducted extensive researches on the multi-field coupling problem in in-situ leaching mining. However, the impact mechanism of blasting damage on the multi-scale pore structure of rocks is still unclear, and there is a lack of a relationship model between blasting parameters and energy evolution. The method for obtaining kinetic parameters of multi-phase chemical reactions in CO₂+O₂ leaching system has limitations, making it difficult to accurately describe the dynamic equilibrium process of mineral dissolution and precipitation, and making it difficult to characterize the synergistic evolution law of macroscopic seepage field and microscopic pore structure.

### SUMMARY

The present disclosure provides a method for predicting in-situ leaching mining effect of sandstone-type uranium deposits after blasting, which solves the problem that it is difficult to simulate the multi-field coupling and solute transfer of CO₂+O₂ in-situ leaching in sandstone-type uranium deposits by coupling commonly used software COMSOL and chemical software PHREEQC in the industry. The present disclosure can realize multi-scale dynamic simulation of migration of uranium, as well as simulation of multiphysics coupling, geochemical reactions, and other situations under CO₂+O₂ in-situ leaching solute transport, and improve the accuracy of predicting the migration of uranium.

The present disclosure provides a method for predicting in-situ leaching mining effect of sandstone-type uranium deposits after blasting, including:
step S1: based on a finite element analysis platform, establishing an HJC (English full name of which is Holmquist-Johnson-Cook, and is a constitutive model for describing mechanical manners of rocks under impact and high pressure) rock-blasting constitutive model, and carrying out a blasting numerical simulation to obtain a cloud map of blasting crack damage;
step S2: based on geostress field data measured by distributed acoustic sensing, calibrating the cloud map of blasting crack damage by using a Kriging interpolation algorithm to obtain a calibrated cloud map of blasting crack damage;
step S3: establishing an original COMSOL multiphysics model based on the calibrated cloud map of blasting crack damage and a COMSOL Multiphysics software (which is a multiphysics coupling simulation platform based on the finite element method, and can support modeling, simulation, and optimization analysis of complex multidisciplinary systems in engineering and science fields), and loading an oxidation-reduction potential and a degree of acidity or alkalinity of a leaching solution monitored by electrochemical sensors as boundary conditions into the original COMSOL multiphysics model to obtain a COMSOL multiphysics model;
step S4: establishing a coupling interface between the COMSOL (which is a multiphysics coupling simulation platform based on the finite element method, and can support modeling, simulation, and optimization analysis of complex multidisciplinary systems in engineering and science fields) multiphysics model and PHREEQC (which is a professional hydrogeochemical simulation software used for researching complex geochemical reactions, mineral dissolution, and precipitation in aqueous solution systems, and quantitatively calculating and analyzing multi-component ion balance) based on MATLAB, determining an optimal time step for a seepage-dissolution coupling calculation stage within a cycle duration, and inputting the optimal time step into the COMSOL multiphysics model to obtain an initial concentration in the COMSOL Multiphysics software;
step S5: mapping the initial concentration to the PHREEQC, and using the MATLAB to call the PHREEQC for geochemical reaction calculation based on equilibrium constraint conditions of a CO₂+O₂-water-rock reaction, to obtain results of the geochemical reaction calculation;
step S6: saving the results of the geochemical reaction calculation, running files of the COMSOL Multiphysics software, and re-entering the results of the geochemical reaction calculation into the PHREEQC as an initial value for a next time step to obtain a dynamic cyclic iterative simulation;
step S7: dynamically correcting migration coefficients of uranyl complexes in the dynamic cyclic iterative simulation by integrating a parameter adaptive matching function driven by an LSTM neural network, to obtain corrected migration coefficients of uranyl complexes; and
step S8: repeating steps S4 to S7 until the cycle duration is reached and outputting multi-scale dynamic simulation results of migration of uranium.

In some embodiments, in step S1, establishing the HJC rock-blasting constitutive model, and carrying out the blasting numerical simulation to obtain the cloud map of blasting crack damage includes:
establishing the HJC rock-blasting constitutive model in the finite element analysis platform by defining a type and a model size of element materials; where the element materials include: rock, air, and explosives;
defining boundary conditions for geostress, a dynamic compressive strength of the rock, a JWL state equation for the explosives, and material properties of the air; and
applying the boundary conditions for geostress to the HJC rock-blasting constitutive model, and performing a blasting numerical simulation to the HJC rock-blasting constitutive model based on the dynamic compressive strength of the rock, the JWL state equation for the explosives, and the material properties of the air, to obtain the cloud map of blasting crack damage; where the boundary conditions for geostress include: a vertical constrained boundary and a horizontal non reflective boundary.

In some embodiments, in step S2, based on the geostress field data measured by the distributed acoustic sensing, calibrating the cloud map of blasting crack damage by using the Kriging interpolation algorithm to obtain the calibrated cloud map of blasting crack damage includes:
obtaining spatial distribution characteristics of a stress field based on the geostress field data measured by the distributed acoustic sensing, and establishing dynamic-damage-evolution input conditions;
calibrating an anisotropic deformation and a crack propagation path of a damage area in the cloud map of blasting crack damage by using the Kriging interpolation algorithm and based on the spatial distribution characteristics of the stress field and the dynamic-damage-evolution input conditions, to obtain a two-dimensional correction model for the damage area and obtain the calibrated cloud map of blasting crack damage.

In some embodiments, the COMSOL multiphysics model in step S3 is a numerical model coupling a porous media dilute matter transfer equation, a Darcy flow equation, a mineral dissolution domain ordinary differential equation system, and a uranyl complexation reaction diffusion equation.

In some embodiments, in step S4, establishing the coupling interface between the COMSOL multiphysics model and the PHREEQC based on the MATLAB, determining the optimal time step for the seepage-dissolution coupling calculation stage within the cycle duration, and inputting the optimal time step into the COMSOL multiphysics model to obtain the initial concentration in the COMSOL Multiphysics software includes:
establishing the coupling interface between the COMSOL multiphysics model and the PHREEQC based on the MATLAB;
optimizing the cycle duration through a leaching efficiency to obtain an optimized cycle duration;
determining an adaptive control algorithm for time step based on evolution characteristics of a gradient of uranium concentrations, and obtaining the optimal time step for the seepage-dissolution coupling calculation stage within the optimized cycle duration based on the adaptive control algorithm; and
inputting the optimal time step into the COMSOL multiphysics model to obtain the initial concentration in the COMSOL Multiphysics software.

In some embodiments, the results of the geochemical reaction calculation in step S5 include: a dataset comprising a concentration of a liquid-phase element and a precipitation of a secondary mineral in pores.

In some embodiments, in step S7, dynamically correcting the migration coefficients of uranyl complexes in the dynamic cyclic iterative simulation by integrating the parameter adaptive matching function driven by the LSTM neural network, to obtain the corrected migration coefficients of uranyl complexes includes:
inputting the oxidation-reduction potential and the degree of acidity or alkalinity of the leaching solution monitored by the electrochemical sensors and initial migration coefficients of uranyl complexes calculated by the COMSOL multiphysics model to the LSTM neural network for a dynamic correction factor prediction, to obtain a dynamic correction factor; and
according to the dynamic correction factor, automatically adjusting the migration coefficients of uranyl complexes by integrating the parameter adaptive matching function driven by the LSTM neural network, to obtain the corrected migration coefficients of uranyl complexes.

In some embodiments, the multi-scale dynamic simulation results of migration of uranium in step S8 include: a distribution data for uranium concentration and a prediction for migration paths of uranium.

A system for predicting in-situ leaching mining effect of sandstone-type uranium deposits after blasting is also provided, which including:
a first model-establishment module, configured for establishing an HJC rock-blasting constitutive model based on a finite element analysis platform, and carrying out a blasting numerical simulation to obtain a cloud map of blasting crack damage;
a calibration module, configured for calibrating the cloud map of blasting crack damage by using a Kriging interpolation algorithm and based on geostress field data measured by distributed acoustic sensing to obtain a calibrated cloud map of blasting crack damage;
a second model-establishment module, configured for constructing an original COMSOL multiphysics model based on the calibrated cloud map of blasting crack damage and a COMSOL Multiphysics software, and loading an oxidation-reduction potential and a degree of acidity or alkalinity of a leaching solution monitored by electrochemical sensors as boundary conditions into the original COMSOL multiphysics model to obtain a COMSOL multiphysics model;
a determination module, configured for establishing a coupling interface between the COMSOL multiphysics model and PHREEQC based on MATLAB, determining an optimal time step for a seepage-dissolution coupling calculation stage within a cycle duration, and inputting the optimal time step into the COMSOL multiphysics model to obtain an initial concentration in the COMSOL Multiphysics software;
a calculation module, configured for mapping the initial concentration to the PHREEQC, and using the MATLAB to call the PHREEQC for geochemical reaction calculation based on equilibrium constraint conditions of a CO₂+O₂-water-rock reaction, to obtain results of the geochemical reaction calculation;
an iterative-simulation module, configured for saving the results of the geochemical reaction calculation, running files of the COMSOL Multiphysics software, and re-entering the results of the geochemical reaction calculation into the PHREEQC as an initial value for a next time step to obtain a dynamic cyclic iterative simulation;
a correction module, configured for dynamically correcting migration coefficients of uranyl complexes in the dynamic cyclic iterative simulation by integrating a parameter adaptive matching function driven by an LSTM neural network, to obtain corrected migration coefficients of uranyl complexes; and
an output module, configured for repeating steps S4 to S7 until the cycle duration is reached and outputting multi-scale dynamic simulation results of migration of uranium.

An electronic device is further provided, which includes a memory and a processor, where the memory stores a computer program, and when the computer program is called by the processor, the above method for predicting in-situ leaching mining effect of sandstone-type uranium deposits after blasting is implemented.

In summary, the present disclosure provides the method for predicting in-situ leaching mining effect of sandstone-type uranium deposits after blasting. Compared with traditional techniques, the present disclosure has the following advantages:
(1) The present disclosure solves the problem that it is difficult to simulate the multi-field coupling and solute transfer of CO₂+O₂ in-situ leaching in sandstone-type uranium deposits by coupling commonly used software COMSOL and chemical software PHREEQC in the industry.
(2) The present disclosure establishes a seepage-stress chemical coupling model of blasting-induced damage rock mass through COMSOL multiphysics model, and combines PHREEQC for geochemical reaction calculation, realizing multi-scale dynamic simulation of migration of uranium during injection process of leaching agent and improving the accuracy of predicting migration of uranium.
(3) The method of coupling COMSOL and PHREEQC using MATLAB provided in the present disclosure simulates multiphysics coupling, geochemical reactions, and other situations under in-situ leaching solute transport of CO₂+O₂.
(4) The present disclosure has the advantages of small error and strong scalability, greatly improving the applicability of migration models of reactive solute and increasing the possibility of secondary development of COMSOL-PHREEQC.

The technical method of the present disclosure will be further described in detail through the accompanying drawings and embodiments.

### BRIEF DESCRIPTION OF THE DRAWINGS

FIG. 1 is a schematic flowchart of the method for predicting in-situ leaching mining effect of sandstone-type uranium deposits after blasting provided by embodiments of the present disclosure.

FIG. 2 is a schematic diagram of numerical simulation of blasting-induced infiltration under initial geostress provided by embodiments of the present disclosure.

FIG. 3 is a schematic diagram of monitoring points for solute transport model provided by embodiments of the present disclosure.

FIG. 4 is a schematic diagram of changes in CaCO₃ precipitation at monitoring points provided by embodiments of the present disclosure.

FIG. 5 shows an in-situ leaching cloud map of uranium concentration within 900 days under COMSOL-PHREEQC coupling provided by embodiments of the present disclosure.

FIG. 6 shows a curve that shows changes in uranium concentration under COMSOL-PHREEQC coupling provided by embodiments of the present disclosure.

### DETAILED DESCRIPTION OF THE EMBODIMENTS

The following provides further explanation of the technical method of the present disclosure through the accompanying drawings and embodiments. It should be noted that, unless otherwise specified, the relative arrangement, numerical expressions, and values of the components and steps described in these embodiments do not limit the scope of the present disclosure.

The following description of at least one exemplary embodiment is merely illustrative and should not be construed as any limitation on the present disclosure or application or use thereof.

Technologies, systems, and devices known to ordinary technical personnel in related fields may not be discussed in detail, but in appropriate circumstances, they should be considered as part of the specification.

In all examples shown and discussed here, any specific value should be interpreted as merely illustrative and not restrictive. Therefore, other examples of exemplary embodiments may have different values.

Unless otherwise defined, the technical or scientific terms used in the present disclosure shall have the usual meanings as understood by those skilled in the art to which the present disclosure belongs.

The present disclosure provides a method for predicting in-situ leaching mining effect of sandstone-type uranium deposits after blasting, which includes following steps S1 to S8.

In step S1, based on a finite element analysis platform, an HJC rock-blasting constitutive model is established, and a blasting numerical simulation is carred out to obtain a cloud map of blasting crack damage.

It can be understood that the finite element analysis platform can be the LS-DYNA finite element analysis platform, which can construct the HJC rock-blasting constitutive model, assign isotropic boundary conditions of initial geostress: σₓ=σ_{y}=5 MPa, define the dynamic compressive strength of the rock, the JWL state equation for the explosives, and the material properties of the air by writing a K file, perform numerical simulation of blasting under geostress conditions, and obtain the cloud map of blasting crack damage.

In some embodiments, the specific processes of establishing the HJC rock-blasting constitutive model, and carrying out the blasting numerical simulation to obtain the cloud map of blasting crack damage in step S1 are as follows:

In the finite element analysis platform, the HJC rock-blasting constitutive model is established by defining a type and a model size of element materials. The element materials include: rock, air, and explosives.

Boundary conditions for geostress, a dynamic compressive strength of the rock, a JWL state equation for the explosives, and material properties of the air are defined.

The boundary conditions for geostress are applied to the HJC rock-blasting constitutive model, and a blasting numerical simulation is performed to the HJC rock-blasting constitutive model based on the dynamic compressive strength of the rock, the JWL state equation for the explosives, and the material properties of the air, to obtain the cloud map of blasting crack damage. The boundary conditions for geostress include: a vertical constrained boundary and a horizontal non reflective boundary.

In step S2, based on geostress field data measured by distributed acoustic sensing, the cloud map of blasting crack damage is calibrated by using a Kriging interpolation algorithm to obtain a calibrated cloud map of blasting crack damage.

In some embodiments, the specific processes of calibrating the cloud map of blasting crack damage by using the Kriging interpolation algorithm based on the geostress field data measured by the distributed acoustic sensing, to obtain the calibrated cloud map of blasting crack damage in step are as follows:

Based on the geostress field data measured by the distributed acoustic sensing, spatial distribution characteristics of a stress field are obtained, and dynamic-damage-evolution input conditions are established.

Based on the spatial distribution characteristics of the stress field and the dynamic-damage evolution input conditions, an anisotropic deformation and a crack propagation path of a damage area in the cloud map of blasting crack damage are calibrated by using the Kriging interpolation algorithm, to obtain a two-dimensional correction model for the damage area and obtain the calibrated cloud map of blasting crack damage.

In step S3, based on the calibrated cloud map of blasting crack damage and a COMSOL Multiphysics software, an original COMSOL multiphysics model is established, and an oxidation-reduction potential and a degree of acidity or alkalinity of a leaching solution monitored by electrochemical sensors as boundary conditions are loaded into the original COMSOL multiphysics model to obtain a COMSOL multiphysics model.

It can be understood that the R2V format conversion plugin is used to import the blasting-induced damage cloud map output by LS-DYNA into COMSOL Multiphysics to establish a two-dimensional geological model with a length of 105 m and a width of 70 m, and then Eh/pH dynamic boundary conditions feedback in a real time by underground electrochemical sensors are embed, and the input settings of material parameters and the multiphysics model are completed, and a transient solver is configured.

In some embodiments, the COMSOL multiphysics model in step 3 is a numerical model coupling a porous media dilute matter transfer equation, a Darcy flow equation, a mineral dissolution domain ordinary differential equation system, and a uranyl complexation reaction diffusion equation.

In step S4, a coupling interface between the COMSOL multiphysics model and PHREEQC is established based on MATLAB, an optimal time step for a seepage-dissolution coupling calculation stage within a cycle duration is determined, and the optimal time step is input into the COMSOL multiphysics model to obtain an initial concentration in the COMSOL Multiphysics software.

In some embodiments, the specific processes of establishing the coupling interface between the COMSOL multiphysics model and the PHREEQC based on the MATLAB, determining the optimal time step for the seepage-dissolution coupling calculation stage within the cycle duration, and inputting the optimal time step into the COMSOL multiphysics model to obtain the initial concentration in the COMSOL Multiphysics software are as follows:

The coupling interface between the COMSOL multiphysics model and the PHREEQC is established based on the MATLAB.

The cycle duration is optimized through a leaching efficiency to obtain an optimized cycle duration.

An adaptive control algorithm is determined for time step based on evolution characteristics of a gradient of uranium concentrations, and the optimal time step for the seepage-dissolution coupling calculation stage within the optimized cycle duration is obtained based on the adaptive control algorithm.

The optimal time step is input into the COMSOL multiphysics model to obtain the initial concentration in the COMSOL Multiphysics software.

In step S5, the initial concentration is mapped to the PHREEQC, and the MATLAB is used to call the PHREEQC for geochemical reaction calculation based on equilibrium constraint conditions of a CO₂+O₂-water-rock reaction, to obtain results of the geochemical reaction calculation.

In some embodiments, the results of the geochemical reaction calculation in step S5 include: a dataset including a concentration of a liquid-phase element and a precipitation of a secondary mineral in pores.

In step S6, the results of the geochemical reaction calculation are saved, running files of the COMSOL Multiphysics software are run, and the results of the geochemical reaction calculation are re-entered into the PHREEQC as an initial value for a next time step to obtain a dynamic cyclic iterative simulation.

In step S7, migration coefficients of uranyl complexes in the dynamic cyclic iterative simulation are dynamically corrected by integrating a parameter adaptive matching function driven by an LSTM neural network, to obtain corrected migration coefficients of uranyl complexes.

In some embodiments, the specific processes of dynamically correcting the migration coefficients of uranyl complexes in the dynamic cyclic iterative simulation by integrating the parameter adaptive matching function driven by the LSTM neural network, to obtain the corrected migration coefficients of uranyl complexes are as follows:

The oxidation-reduction potential and the degree of acidity or alkalinity of the leaching solution monitored by the electrochemical sensors and initial migration coefficients of uranyl complexes calculated by the COMSOL multiphysics model are input to the LSTM neural network for a dynamic correction factor prediction, to obtain a dynamic correction factor.

According to the dynamic correction factor, the migration coefficients of uranyl complexes are automatically adjusted by integrating the parameter adaptive matching function driven by the LSTM neural network, to obtain the corrected migration coefficients of uranyl complexes.

In step S8, steps S4 to S7 are repeated until the cycle duration is reached and multi-scale dynamic simulation results of migration of uranium are output.

In some embodiments, the multi-scale dynamic simulation results of migration of uranium in step S8 include: a distribution data for uranium concentration and a prediction for migration paths of uranium.

### EMBODIMENTS

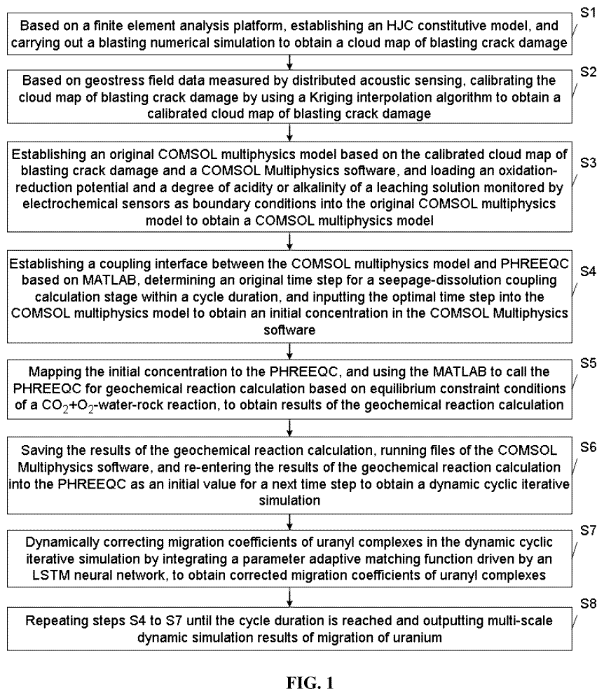

The embodiments of the present disclosure provide a method for predicting CO₂+O₂ in-situ leaching mining effect of sandstone-type uranium deposits after blasting. The method generates the cloud map of blasting crack damage based on ANSYS/LS-DYNA, integrates DAS monitoring data with Kriging inversion model to calibrate fracture network parameters, develops the coupling interface for COMSOL-PHREEQC multiphysics and chemical field based on the MATLAB, and combines on-site working condition information to construct the multi-scale coupling model for blasting-induced fracture network-seepage-chemical solute migration. The regulation mechanism of CO₂+O₂-water-rock reaction on uranium dissolution and uranyl ion transport path under blasting-induced damage conditions is analyzed, and the evolution law of solute transfer under dynamic coupling of stress field-seepage field-chemical field is revealed, as shown in FIG. 1. The specific details are as follows:

In step S1, the HJC (English full name of which is Hyperbolic Joint Constitutive) rock-blasting constitutive model (i.e., the two-dimensional blasting model) is established based on the ANSYS software or the LS-DYNA software, and the grid division is performed. Then the vertical constraint boundary oy and the transverse non reflection boundary ox are defined. The geostress boundary condition of σₓ=σ_{y}=5 MPa is applied to the model. The parameters in the k file is modified using Visual Studio Code to obtain the cloud map of blasting crack damage under geostress.

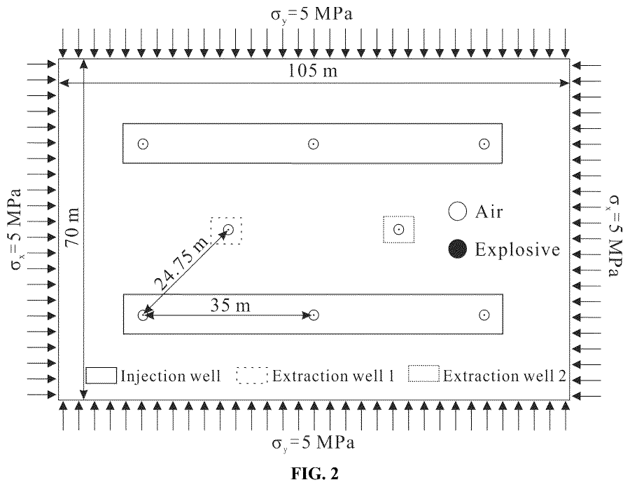

In step S1, the type of element material is defined by the process of “Preprocessor”→“Element Type/Material Props”→“Material Models” in the LS-DYNA software, and the term of “3D Solid 164” is selected. Then the dimension of the HJC rock-blasting constitutive model is defined in the “Modeling” module, with a dimension of 105 m in length and 70 m in width. The diameter for air Rₐᵢᵣ is defined to be equal to 1 m, and a radius for blasting cannon hole R_{cannon} is defined to be equal to 0.1 m. The terms “Meshing”→“MeshTool” are used to perform the grid division on the rock, air, and explosives. The initial time of explosion is set based on the terms “Solution”→“Time Controls”→“Solution Time”→“25000” (the initial time of explosion is set to be 25,000 μs). The geostress is added based on the terms “Keyword”→“DEFIND”→“CURVE” (σₓ=σ_{y}=5 MPa), and the file is saved as “dy1. k” and “dy2. k”, as shown in FIG. 2. Then the parameters of explosives and air materials are deleted from the “dy1. k” file, and the “dy1. k” file after deleting is run in the term “LS-Run”. A dynain initialization file with stress inheritance characteristics is generated by dynamically compiling the “dy1. k” file, and the dynain initialization file is imported into the model of explosives and air to induce the rock mass to be in a state of geostress. Then the “dy2. k” file is run in the term “LS-Run” to obtain the blasting-induced damage cloud map under geostress.

In step S2, the geostress data measured by the distributed acoustic sensing (DAS) are fused, and the true form of the blasting-induced damage area is calibrated using the Kriging interpolation algorithm to obtain calibrated cloud map of blasting crack damage.

The step S2 involves real-time capture of dynamic strain signals of blasting-induced stress waves using distributed acoustic sensing (sampling frequency ≥10 kHz), combined with denoising and Fourier transform to extract energy attenuation characteristics in the frequency domain to obtain the spatial distribution characteristics in the stress field. The generalized Hooke's law is used to convert the stress field into a dynamic stress tensor. An anisotropic variation function model is established based on the Kriging interpolation algorithm. The numerical simulated cloud map of blasting crack damage and stress gradient extreme value data are integrated. The Levenberg-Marquardt inversion algorithm is used to dynamically correct the parameters of the HJC rock-blasting constitutive model and the geometric parameters of the fracture network (connectivity error ≤8%). The spatial matching degree of the calibration model is cross verified through microseismic monitoring data (F1-score ≥0.85). Finally, the dynamic update of the permeability tensor matrix and the seepage-chemical coupling boundary conditions is achieved, and the calibrated cloud map of blasting crack damage is obtained.

In step S3, the R2V format conversion plugin is used to import the calibrated cloud map of blasting crack damage into the COMSOL Multiphysics software to establish a two-dimensional geological model with a length of 105 m and a width of 70 m, namely the original COMSOL multiphysics model. The dynamic boundary conditions of an oxidation-reduction potential Eh and a degree of acidity or alkalinity of a leaching solution feedback in a real time by the downhole electrochemical sensors are embed into the original COMSOL multiphysics model, to obtain the COMSOL multiphysics model. Then the input settings of material parameters and multiphysics model are completed, and the transient solver is configured.

Specifically, in step S3, the “R2V. exe” program is opened, and the calibrated cloud map of blasting crack damage under geostress is selected. The calibrated cloud map of blasting crack damage is exported as a .dsf format file through the terms “Image”, “Conversion”, and “24 bit RGB, Grayscale”, and the selected “Auto Vectorization” at the vector location. The COMSOL software is opened, and the .dxf geometric fracture and well group model are imported in the geometry component section. A coupled numerical model (namely the original COMSOL multiphysics model) that includes the porous medium dilute material transfer equation, Darcy flow equation, mineral dissolution domain ordinary differential equation system, and uranyl complexation reaction diffusion equation is established. The dynamic changes of Eh and pH monitored in real-time by electrochemical sensors installed in the underground tunnels of uranium mines are extracted (sampling interval ≤5 seconds), and the chemical activity signals in solute transport processes are captured. Then the system loads the measured Eh and pH values from the sensors as boundary conditions into the original COMSOL multiphysics model to obtain the COMSOL multiphysics model.

When pH<5.5, hexavalent uranium (U(VI)) exists mainly in the form of uranyl ions UO₂²⁺, then it interacts with H⁺ in water to promote the formation of complex ions, and the solubility of U(VI) increases sharpl. Then a transient solver with a convergence tolerance ≤1e⁻⁵ is configured.

In step S4, a coupling interface for COMSOL-PHREEQC is established based on the MATLAB, a cycle durtion of 900 days is set, and the optimal time step of 100 days for the seepage-dissolution coupling calculation stage of COMSOL and PHREEQC is selected. The specific codes of this process are as follows:

$$start\_day = 0 ;$$

$$end\_day = 900 ;$$

$$total\_days = end\_day - start\_day ;$$

$$dt\_days = 100 ;$$

$$num\_steps = total\_days / dt\_days ;$$

$$phreeqc\_exe = ' phreeqc . exe ' ;$$

$$comsol\_model = ' 3336. mph ' ;$$

import com.comsol.model.
import com.comsol.model.util.

$$model = mphload ( comsol\_model ) .$$

In step S5, the initial concentration of COMSOL is mapped to the PHREEQC.pqi file, and the MATLAB is used to call the PHREEQC for geochemical reaction calculation based on equilibrium constraint conditions of a CO₂+O₂-water-rock reaction, to obtain results of the geochemical reaction calculation.

Specifically, in step S5, the obtained COMSOL file is moved to a recognized path in MATLAB, and MATLAB is called to place the required concentration parameters into the PHREEQC1.pqi file. The specific codes of this process are as follows:

$$x\_coord = 52.9 ;$$

$$y\_coord = 61.6 ;$$

$${O}_{2} \_values = mphinterp ( model , \{ ' comp 1. {cO}_{2} ' \} , ' coord ' , [ x\_coord ; y\_coord ] ) ;$$

$${O}_{2} \_kgw = {O}_{2} \_values / 1000 ;$$

save (‘C:\Users\qifei\.comsol\v63\llmatlab\comsol_O₂.mat’,‘O₂_kgw’);
load (‘C:\Users\qifei\.comsol\v63\llmatlab\comsol_O₂.mat’,O₂_kgw’);

$$template = fileread ( ' C : \backslash Users \backslash qifei \text{\textbackslash .} comsol \backslash v 63. \backslash llmatlab \backslash Phrqc 1. pqi ' ) ;$$

$$filled\_template = strrep ( template , ' \{ {O}_{2} \} ' , num 2 str ( {O}_{2} \_kgw ( 1 ) , ' \% \text{.4} f ' ) ) ;$$

$$output\_pqi = sprintf ( ' C : \backslash \backslash Users \backslash \backslash qifei \backslash \backslash . comsol \backslash \backslash v 63 \backslash \backslash llmatlab \backslash \backslash Phrqc 2. pqi ' ) ;$$

$$fid = fopen ( output\_pqi , ' w ' ) ;$$

fprintf(fid,‘% s’,filled_template);
fclose(fid);
disp(‘PHREEQC input file has been generated’);

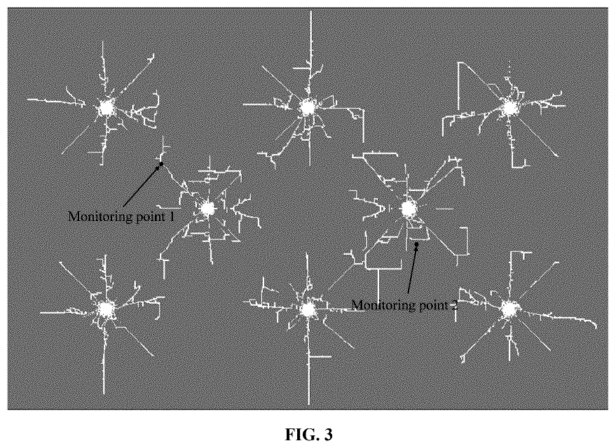

Based on the equilibrium constraint conditions of CO₂+O₂-water-rock reaction, a water solution with an initial temperature of 25° C. is set to simulate the dynamic dissolution-precipitation process of leaching solution and minerals. The “monitoring point 1” and “monitoring point 2” are set up respectively at the matrix and fracture of the COMSOL multiphysics model, as shown in FIG. 3. Then MATLAB is called to run the PHREEQC.pqi input file for iterative calculation, and finally the mineral saturation index (SI) and ion concentration (Ca²⁺, SO₄²⁻, etc.) at the monitoring point are extracted.

In step S6, the obtained mineral and ion content are saved to a file, the COMSOL file is run at the same time, and the obtained concentration is re-entered into the PHREEQC file for data replacement to prepare for the simulation in the next time step, that is, a simulation of dynamic cyclic iterative can be achieved.

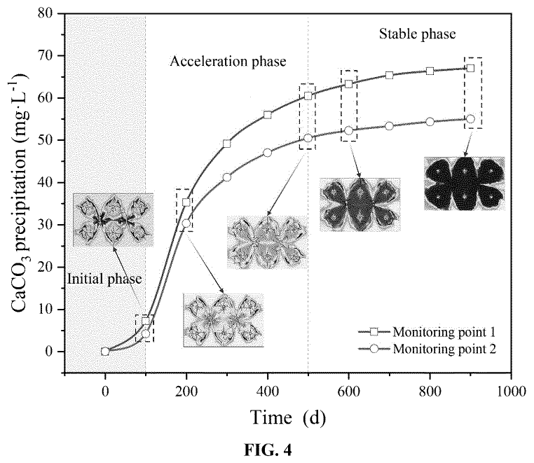

Specifically, in step S6, Ca²⁺, Mg²⁺, CO₃²⁻, and CaCO₃ ions and precipitation concentrations are extracted and saved to files “Ca²⁺_txt”, “Mg²⁺_txt”, “CO₃²⁻_txt”, and “CaCO₃_txt”, respectively, and the variation curves of ions and precipitation over time are plotted, as shown in FIG. 4. In FIG. 4, the CaCO₃ precipitation concentration exhibits an initial phase, an acceleration phase, and a stable phase. The initial phase is mainly in an acidic environment, while an inversion of the degree of acidity and alkalinity in the acceleration phase leads to an enhanced reaction. As the reaction progresses, the ion concentration gradually decreases, resulting in the CaCO₃ precipitation concentration gradually stabilizing in the later stage.

When the COMSOL file is run, it is assumed that the pore is in a fully saturated state, relevant mathematical models and equations can be derived. The seepage of leaching solution in the ore pore can refer to Darcy's law:

$$S \frac{\partial P}{\partial t} + ∇ \cdot u = - \frac{\partial e}{\partial t} + Q ;$$

$$u = - \frac{k}{η} ( ∇ P + ρ g ∇ z ) ;$$

where t represents time; S represents a water storage coefficient of the rock mass; P represents a pressure of water; u represents a seepage velocity of the fluid in the matrix; e represents the volumetric strain of the rock block; Q represents the source sink term of seepage; k represents the permeability of porous medium; n represents the dynamic viscosity of fluid; p represents the density of fluid; ∇P represents the pressure gradient of water; g represents the acceleration of gravity; and ∇z represents the gradient of height.

The CO₂+O₂ in-situ leaching uranium model is established based on the convection-dispersion equation. The model has taken into account the adsorption and dispersion of solutes. The solute transport equation in COMSOL can be expressed as:

$$( θ + {ρ}_{b} {k}_{b} ) \frac{\partial {c}_{i}}{\partial t} + {c}_{i} \frac{\partial θ}{\partial t} - ∇ ( D ∇ {c}_{i} ) + {u}_{i} \cdot ∇ {c}_{i} = {S}_{i} ;$$

where θ represents the volume fraction of liquid; ρ_{b} represents the volume density; k_{b} represents the adsorption isotherm; cᵢ represents the concentration of species i in liquid; u₁ represents the node velocity obtained from flow model; D represents the diffusion coefficient; and Sᵢ represents the source term.

Based on concentrations of Ca²⁺, Mg²⁺, and HCO₃⁻ ions generated in the current time step, a script is used to batch modify the hydrochemical parameters of the PHREEQC input file (*.pqi). The initial conditions are automatically replaced through a code interface, and the updated results are saved as the initial values for the next time step, achieving dynamic cyclic iterative simulation of multi-stage reactions.

In step S7, the migration coefficients of uranyl complexes are dynamically corrected by integrating a parameter adaptive matching function driven by the LSTM neural network, to obtain corrected migration coefficients of uranyl complexes.

Specifically, in step S7, a time series dataset is established based on historical simulations and measured data, which includes characteristics such as pH, Eh, UO₂²⁺ ion concentration, CO₃²⁻ ion concentration, Ca²⁺ ion concentration, and temperature. Subsequently, the LSTM neural network is used for modeling, the current hydrochemical parameters are input, and the predicted value (D_pred) of migration coefficient of uranyl complexes is output. In each iteration step of the PHREEQC simulation, the LSTM model is called in a real time, and the water chemistry data obtained online is input into the model to predict D_pred. After sensitivity analysis verification, the D_pred replaces the migration parameters calculated by traditional empirical formulas. The numerical simulation conditions are dynamically updated through the PHREEQC interface to optimize the multiphysics coupling and solute transfer in the uranium migration process, and the corrected migration coefficients of uranyl complexes can be obtained.

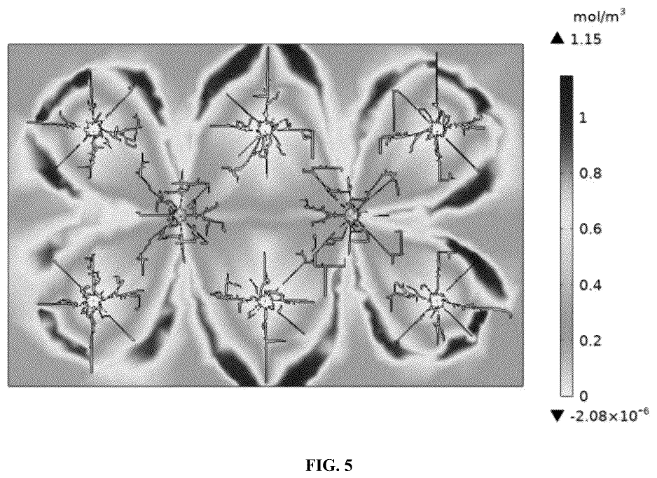

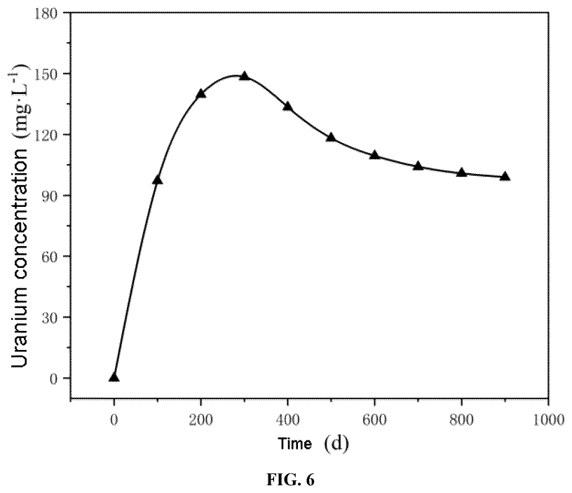

In step S8, the COMSOL-PREEQC coupling calculation process is executed in a loop, and the concentration of uranium ion in the leachate is monitored in a real time. The instantaneous uranium concentration is calculated at the current time node, and the uranium concentration cloud map for the 900th day can be finally obtained, as shown in FIG. 5. The uranium concentration data obtained in each cycle will be automatically stored in time series, and finally the change curve of uranium concentration over time will be generated through the data visualization module, as shown in FIG. 6.

The method provided by the present disclosure for exploring multiphysics coupling-solute transfer mechanism and law of CO₂+O₂ in-situ leaching mining of sandstone-type uranium deposits after blasting is based on ANSYS/LS-DYNA software to establish a numerical model of blasting under geostress. And MATLAB is used to establish a coupling interface between COMSOL and PHREEQC, which helps to analyze the regulation mechanism of CO₂+O₂-water-rock reaction on uranium dissolution and uranyl ion transport path under blasting-induced damage conditions, as well as the evolution law of solute transfer under dynamic coupling of stress field-seepage field-chemical field. That is, the method provided by the present disclosure has practical guiding significance.

The present disclosure also provides a system for predicting in-situ leaching mining effect of sandstone-type uranium deposits after blasting, which includes: a first model-establishment module, a calibration module, a second model-establishment module, a determination module, a calculation module, an iterative-simulation module, a correction module, and an output module.

The first model-establishment module is configured for establishing an HJC rock-blasting constitutive model based on a finite element analysis platform, and carrying out a blasting numerical simulation to obtain a cloud map of blasting crack damage.

The calibration module is configured for calibrating the cloud map of blasting crack damage by using a Kriging interpolation algorithm and based on geostress field data measured by distributed acoustic sensing to obtain a calibrated cloud map of blasting crack damage.

The second model-establishment module is configured for constructing an original COMSOL multiphysics model based on the calibrated cloud map of blasting crack damage and a COMSOL Multiphysics software, and loading an oxidation-reduction potential and a degree of acidity or alkalinity of a leaching solution monitored by electrochemical sensors as boundary conditions into the original COMSOL multiphysics model to obtain a COMSOL multiphysics model.

The determination module is configured for establishing a coupling interface between the COMSOL multiphysics model and PHREEQC based on MATLAB, determining an optimal time step for a seepage-dissolution coupling calculation stage within a cycle duration, and inputting the optimal time step into the COMSOL multiphysics model to obtain an initial concentration in the COMSOL Multiphysics software.

The calculation module is configured for mapping the initial concentration to the PHREEQC, and using the MATLAB to call the PHREEQC for geochemical reaction calculation based on equilibrium constraint conditions of a CO₂+O₂-water-rock reaction, to obtain results of the geochemical reaction calculation.

The iterative-simulation module is configured for saving the results of the geochemical reaction calculation, running files of the COMSOL Multiphysics software, and re-entering the results of the geochemical reaction calculation into the PHREEQC as an initial value for a next time step to obtain a dynamic cyclic iterative simulation.

The correction module is configured for dynamically correcting migration coefficients of uranyl complexes in the dynamic cyclic iterative simulation by integrating a parameter adaptive matching function driven by an LSTM neural network, to obtain corrected migration coefficients of uranyl complexes.

The output module is configured for repeating based on the determining module, the calculation module, the iterative-simulation module, and the correction module until the cycle duration is reached and outputting multi-scale dynamic simulation results of migration of uranium.

The present disclosure further provides an electronic device, which includes a memory and a processor. The memory stores a computer program, and when the computer program is called by the processor, the above method for predicting in-situ leaching mining effect of sandstone-type uranium deposits after blasting is implemented.

Finally, it should be noted that the above embodiments are only used to illustrate the technical method of the present disclosure and not to limit it. Although the present disclosure has been described in detail with reference to the preferred embodiments, ordinary skilled persons in the art should understand that they can still modify or equivalently substitute the technical method of the present disclosure, and these modifications or equivalent substitutions cannot make the modified technical method deviate from the spirit and scope of the technical method of the present disclosure.

What is claimed is:

1. A method for predicting in-situ leaching effects of sandstone-type uranium mining deposits after blasting, comprising:
step S1: based on a finite element analysis platform, establishing an HJC rock-blasting constitutive model, and carrying out a blasting numerical simulation to obtain a cloud map of blasting crack damage;
step S2: based on geostress field data measured by distributed acoustic sensing, calibrating the cloud map of blasting crack damage by using a Kriging interpolation algorithm to obtain a calibrated cloud map of blasting crack damage;
step S3: establishing an original COMSOL multiphysics model based on the calibrated cloud map of blasting crack damage and a COMSOL Multiphysics software, and loading an oxidation-reduction potential and a degree of acidity or alkalinity of a leaching solution monitored by electrochemical sensors as boundary conditions into the original COMSOL multiphysics model to obtain a COMSOL multiphysics model;
step S4: establishing a coupling interface between the COMSOL multiphysics model and PHREEQC based on MATLAB, determining an optimal time step for a seepage-dissolution coupling calculation stage within a cycle duration, and inputting the optimal time step into the COMSOL multiphysics model to obtain an initial concentration in the COMSOL Multiphysics software;
step S5: mapping the initial concentration to the PHREEQC, and using the MATLAB to call the PHREEQC for geochemical reaction calculation based on equilibrium constraint conditions of a CO₂+O₂-water-rock reaction, to obtain results of the geochemical reaction calculation;
step S6: saving the results of the geochemical reaction calculation, running files of the COMSOL Multiphysics software, and re-entering the results of the geochemical reaction calculation into the PHREEQC as an initial value for a next time step to obtain a dynamic cyclic iterative simulation;
step S7: dynamically correcting migration coefficients of uranyl complexes in the dynamic cyclic iterative simulation by integrating a parameter adaptive matching function driven by an LSTM neural network, to obtain corrected migration coefficients of uranyl complexes; and
step S8: repeating steps S4 to S7 until the cycle duration is reached and outputting multi-scale dynamic simulation results of migration of uranium.

2. The method according to claim 1, wherein in step S1, establishing the HJC rock-blasting constitutive model, and carrying out the blasting numerical simulation to obtain the cloud map of blasting crack damage comprises:
establishing the HJC rock-blasting constitutive model in the finite element analysis platform by defining a type and a model size of element materials; wherein the element materials comprise:
rock, air, and explosives;
defining boundary conditions for geostress, a dynamic compressive strength of the rock, a JWL state equation for the explosives, and material properties of the air; and
applying the boundary conditions for geostress to the HJC rock-blasting constitutive model, and performing a blasting numerical simulation to the HJC rock-blasting constitutive model based on the dynamic compressive strength of the rock, the JWL state equation for the explosives, and the material properties of the air, to obtain the cloud map of blasting crack damage; wherein the boundary conditions for geostress comprise: a vertical constrained boundary and a horizontal non reflective boundary.

3. The method according to claim 1, wherein in step S2, based on the geostress field data measured by the distributed acoustic sensing, calibrating the cloud map of blasting crack damage by using the Kriging interpolation algorithm to obtain the calibrated cloud map of blasting crack damage comprises:
obtaining spatial distribution characteristics of a stress field based on the geostress field data measured by the distributed acoustic sensing, and establishing dynamic-damage-evolution input conditions; and
calibrating an anisotropic deformation and a crack propagation path of a damage area in the cloud map of blasting crack damage by using the Kriging interpolation algorithm and based on the spatial distribution characteristics of the stress field and the dynamic-damage-evolution input conditions, to obtain a two-dimensional correction model for the damage area and obtain the calibrated cloud map of blasting crack damage.

4. The method according to claim 1, wherein the COMSOL multiphysics model in step S3 is a numerical model coupling a porous media dilute matter transfer equation, a Darcy flow equation, a mineral dissolution domain ordinary differential equation system, and a uranyl complexation reaction diffusion equation.

5. The method according to claim 1, wherein in step S4, establishing the coupling interface between the COMSOL multiphysics model and the PHREEQC based on the MATLAB, determining the optimal time step for the seepage-dissolution coupling calculation stage within the cycle duration, and inputting the optimal time step into the COMSOL multiphysics model to obtain the initial concentration in the COMSOL Multiphysics software comprises:
establishing the coupling interface between the COMSOL multiphysics model and the PHREEQC based on the MATLAB;
optimizing the cycle duration through a leaching efficiency to obtain an optimized cycle duration;
determining an adaptive control algorithm for time step based on evolution characteristics of a gradient of uranium concentrations, and obtaining the optimal time step for the seepage-dissolution coupling calculation stage within the optimized cycle duration based on the adaptive control algorithm; and
inputting the optimal time step into the COMSOL multiphysics model to obtain the initial concentration in the COMSOL Multiphysics software.

6. The method according to claim 1, wherein the results of the geochemical reaction calculation in step S5 comprise: a dataset comprising a concentration of a liquid-phase element and a precipitation of a secondary mineral in pores.

7. The method according to claim 1, wherein in step S7, dynamically correcting the migration coefficients of uranyl complexes in the dynamic cyclic iterative simulation by integrating the parameter adaptive matching function driven by the LSTM neural network, to obtain the corrected migration coefficients of uranyl complexes comprises:
inputting the oxidation-reduction potential and the degree of acidity or alkalinity of the leaching solution monitored by the electrochemical sensors and initial migration coefficients of uranyl complexes calculated by the COMSOL multiphysics model to the LSTM neural network for a dynamic correction factor prediction, to obtain a dynamic correction factor; and
according to the dynamic correction factor, automatically adjusting the migration coefficients of uranyl complexes by integrating the parameter adaptive matching function driven by the LSTM neural network, to obtain the corrected migration coefficients of uranyl complexes.

8. The method according to claim 1, wherein the multi-scale dynamic simulation results of migration of uranium in step S8 comprise: a distribution data for uranium concentration and a prediction for migration paths of uranium.

9. A system for predicting in-situ leaching effects of sandstone-type uranium mining deposits after blasting, comprising:
a first model-establishment module, configured for establishing an HJC rock-blasting constitutive model based on a finite element analysis platform, and carrying out a blasting numerical simulation to obtain a cloud map of blasting crack damage;
a calibration module, configured for calibrating the cloud map of blasting crack damage by using a Kriging interpolation algorithm and based on geostress field data measured by distributed acoustic sensing to obtain a calibrated cloud map of blasting crack damage;
a second model-establishment module, configured for constructing an original COMSOL multiphysics model based on the calibrated cloud map of blasting crack damage and a COMSOL Multiphysics software, and loading an oxidation-reduction potential and a degree of acidity or alkalinity of a leaching solution monitored by electrochemical sensors as boundary conditions into the original COMSOL multiphysics model to obtain a COMSOL multiphysics model;
a determination module, configured for establishing a coupling interface between the COMSOL multiphysics model and PHREEQC based on MATLAB, determining an optimal time step for a seepage-dissolution coupling calculation stage within a cycle duration, and inputting the optimal time step into the COMSOL multiphysics model to obtain an initial concentration in the COMSOL Multiphysics software;
a calculation module, configured for mapping the initial concentration to the PHREEQC, and using the MATLAB to call the PHREEQC for geochemical reaction calculation based on equilibrium constraint conditions of a CO₂+O₂-water-rock reaction, to obtain results of the geochemical reaction calculation;
an iterative-simulation module, configured for saving the results of the geochemical reaction calculation, running files of the COMSOL Multiphysics software, and re-entering the results of the geochemical reaction calculation into the PHREEQC as an initial value for a next time step to obtain a dynamic cyclic iterative simulation;
a correction module, configured for dynamically correcting migration coefficients of uranyl complexes in the dynamic cyclic iterative simulation by integrating a parameter adaptive matching function driven by an LSTM neural network, to obtain corrected migration coefficients of uranyl complexes; and
an output module, configured for repeating based on the determining module, the calculation module, the iterative-simulation module, and the correction module until the cycle duration is reached and outputting multi-scale dynamic simulation results of migration of uranium.

10. An electronic device comprising a memory and a processor, wherein the memory stores a computer program, and when the computer program is called by the processor, the method for predicting in-situ leaching mining effect of sandstone-type uranium deposits after blasting according to claim 1 is implemented.

11. The electronic device according to claim 10, wherein establishing the HJC rock-blasting constitutive model, and carrying out the blasting numerical simulation to obtain the cloud map of blasting crack damage comprises:
establishing the HJC rock-blasting constitutive model in the finite element analysis platform by defining a type and a model size of element materials; wherein the element materials comprise: rock, air, and explosives;
defining boundary conditions for geostress, a dynamic compressive strength of the rock, a JWL state equation for the explosives, and material properties of the air; and
applying the boundary conditions for geostress to the HJC rock-blasting constitutive model, and performing a blasting numerical simulation to the HJC rock-blasting constitutive model based on the dynamic compressive strength of the rock, the JWL state equation for the explosives, and the material properties of the air, to obtain the cloud map of blasting crack damage; wherein the boundary conditions for geostress comprise: a vertical constrained boundary and a horizontal non reflective boundary.

12. The electronic device according to claim 10, wherein in step S2, based on the geostress field data measured by the distributed acoustic sensing, calibrating the cloud map of blasting crack damage by using the Kriging interpolation algorithm to obtain the calibrated cloud map of blasting crack damage comprises:
obtaining spatial distribution characteristics of a stress field based on the geostress field data measured by the distributed acoustic sensing, and establishing dynamic-damage-evolution input conditions; and
calibrating an anisotropic deformation and a crack propagation path of a damage area in the cloud map of blasting crack damage by using the Kriging interpolation algorithm and based on the spatial distribution characteristics of the stress field and the dynamic-damage-evolution input conditions, to obtain a two-dimensional correction model for the damage area and obtain the calibrated cloud map of blasting crack damage.

13. The electronic according to claim 10, wherein the COMSOL multiphysics model in step S3 is a numerical model coupling a porous media dilute matter transfer equation, a Darcy flow equation, a mineral dissolution domain ordinary differential equation system, and a uranyl complexation reaction diffusion equation.

14. The electronic device according to claim 10, wherein in step S4, establishing the coupling interface between the COMSOL multiphysics model and the PHREEQC based on the MATLAB, determining the optimal time step for the seepage-dissolution coupling calculation stage within the cycle duration, and inputting the optimal time step into the COMSOL multiphysics model to obtain the initial concentration in the COMSOL Multiphysics software comprises:
establishing the coupling interface between the COMSOL multiphysics model and the PHREEQC based on the MATLAB;
optimizing the cycle duration through a leaching efficiency to obtain an optimized cycle duration;
determining an adaptive control algorithm for time step based on evolution characteristics of a gradient of uranium concentrations, and obtaining the optimal time step for the seepage-dissolution coupling calculation stage within the optimized cycle duration based on the adaptive control algorithm; and
inputting the optimal time step into the COMSOL multiphysics model to obtain the initial concentration in the COMSOL Multiphysics software.

15. The electronic device according to claim 10, wherein the results of the geochemical reaction calculation in step S5 comprise: a dataset comprising a concentration of a liquid-phase element and a precipitation of a secondary mineral in pores.

16. The electronic device according to claim 10, wherein in step S7, dynamically correcting the migration coefficients of uranyl complexes in the dynamic cyclic iterative simulation by integrating the parameter adaptive matching function driven by the LSTM neural network, to obtain the corrected migration coefficients of uranyl complexes comprises:
inputting the oxidation-reduction potential and the degree of acidity or alkalinity of the leaching solution monitored by the electrochemical sensors and initial migration coefficients of uranyl complexes calculated by the COMSOL multiphysics model to the LSTM neural network for a dynamic correction factor prediction, to obtain a dynamic correction factor; and
according to the dynamic correction factor, automatically adjusting the migration coefficients of uranyl complexes by integrating the parameter adaptive matching function driven by the LSTM neural network, to obtain the corrected migration coefficients of uranyl complexes.

17. The electronic device according to claim 10, wherein the multi-scale dynamic simulation results of migration of uranium in step S8 comprise: a distribution data for uranium concentration and a prediction for migration paths of uranium.
